(19) United States
(12) Patent Application Publication
(10) Pub. No.: US 2014/0022451 A1
(43) Pub. Date: Jan. 23, 2014

(54) DECORATIVE COVER FOR ELECTRONIC DEVICE AND HOUSING USING SAME

(71) Applicants: FIH (Hong Kong) Limited, Kowloon (HK); SHENZHEN FUTAIHONG PRECISION INDUSTRY CO., LTD., Shenzhen (CN)

(72) Inventor: ZHI-YUN WANG, Shenzhen (CN)

(21) Appl. No.: 13/935,879

(22) Filed: Jul. 5, 2013

(30) Foreign Application Priority Data
Jul. 18, 2012 (CN) 2012102484927

(51) Int. Cl. H04N 5/225

(52) U.S. Cl. CPC H04N 5/2252
USPC 348/375

(57) ABSTRACT

A decorative cover is mounted on a housing of an electronic device corresponding to a flash unit of the electronic device. The decorative cover includes a main portion and a strip portion. The strip portion is formed along a peripheral edge of on a surface of the main portion and defines an opening corresponding to the indent. Two distal ends of the strip portion are beveled, the strip portion is welded and inserted into housing of the electronic device to stick the decorative cover to the housing of the electronic device. A housing of an electronic device employing the decorative cover is also provided.

### BACKGROUND

1. Technical Field

The present disclosure relates to a decorative cover for electronic device, particularly to a decorative cover for covering a flash unit of electronic device and electronic device housing employing the decorative cover.

2. Description of Related Art

Electronic device usually includes a camera module and a decorative cover mounted on a housing of the electronic device for protecting the camera module. The camera module includes a camera and a flash unit, each needing a different decorative cover. However, decorative covers for covering the flash unit of the camera module are small because of size limitation and fragile, and are difficult to assemble. Thus, there is a need for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an electronic device employing a decorative cover according to an exemplary embodiment.

FIG. 2 is an exploded isometric view of the electronic device of FIG. 1.

FIG. 3 is an enlarged view of area III shown in FIG. 2.

FIG. 4 is an isometric view of a decorative cover of the present disclosure.

FIG. 5 is another isometric view of the decorative cover shown in FIG. 4, viewing from another aspect.

FIG. 6 is an isometric view of the decorative cover assembled to a housing of the electronic device.

FIG. 7 is a cross-sectional view taken along line VII-VII of FIG. 6.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

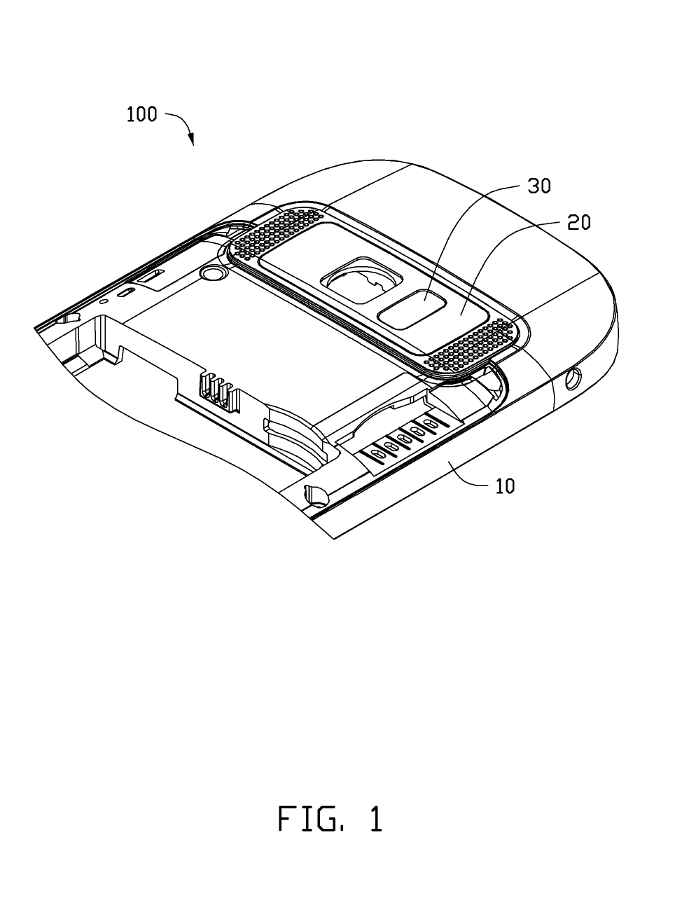

FIG. 1 shows an electronic device 100 according to an exemplary embodiment. The electronic device 100 includes a decorative cover 30. The decorative cover 30 is configured for being used with the electronic device 100. The electronic device 100 may be mobile phones, digital cameras etc. In the present embodiment, the electronic device 100 is a mobile phone. The electronic device 100 further includes a main body 10 and an ornamental piece 20.

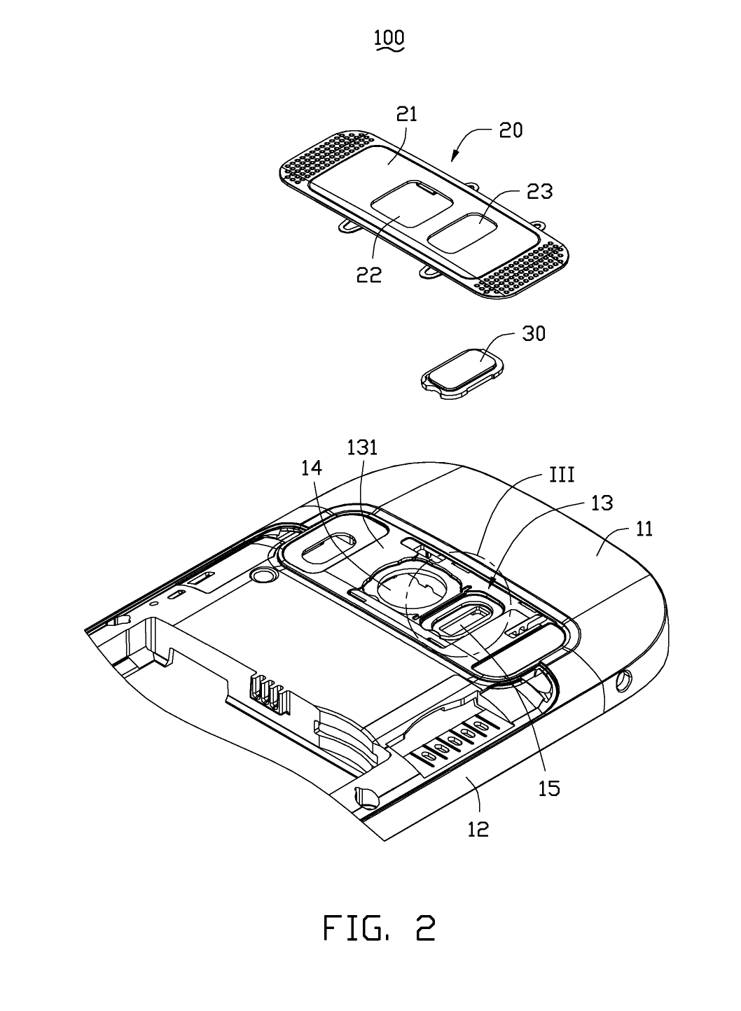

FIG. 2 shows that the main body 10 includes a panel 11, a peripheral wall 12, and a groove 13 defined in the main body 10. The panel 11 is rectangular. The peripheral wall 12 is surrounding a peripheral edge of the panel 11. The groove 13 is defined in the panel 11 and is recessed from an outside of the panel 11. The groove 13 includes a bottom wall 131. A camera hole 14 and a light hole 15 are defined in the bottom wall 131, and are spaced apart from each other. The camera hole 14 receives a camera (not labeled), and the light hole 15 receives a flash unit (not labeled).

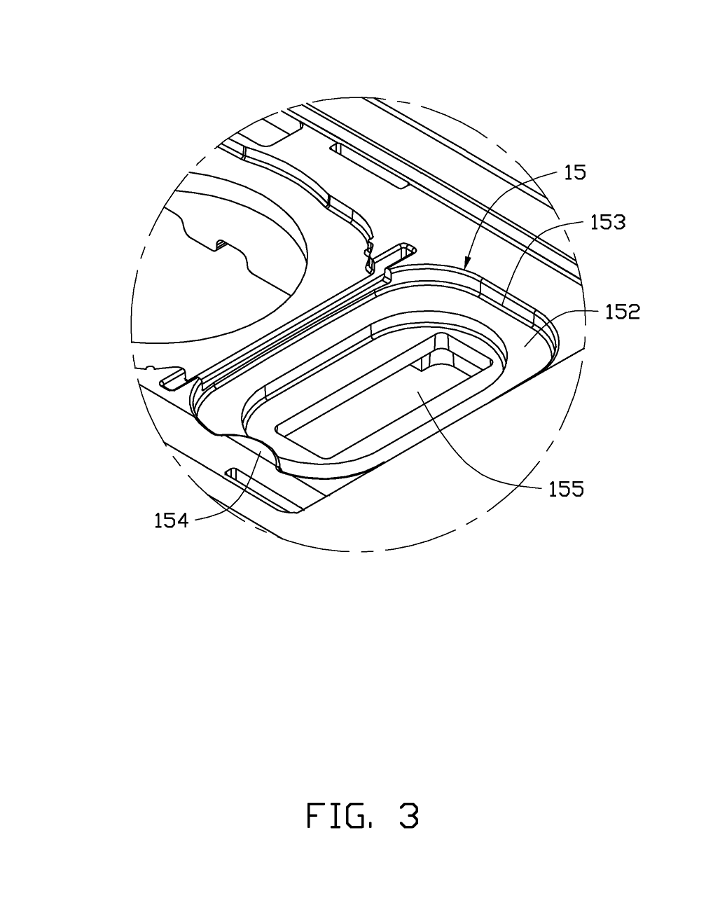

FIG. 3 shows that the light hole 15 is surrounded by stepped-shaped peripheral edge. The peripheral edge includes a supporting portion 152, a surrounding wall 153, and a center hole 155. The supporting portion 152 has a top surface for supporting the decorative cover 30, and has a bottom wall that surrounds the center hole 155 in a center portion. The surrounding wall 153 connects both the top of the supporting portion 152 and the bottom wall 131. The surrounding wall 153 has an arcuate protrusion 154 projecting into the light hole 15.

The ornamental piece 20 is received in the groove 13 and includes a planar surface 21. The ledge 21 defines a first hole 22 and a second hole 23 therein, corresponding to the camera hole 14 and the light hole 15 respectively.

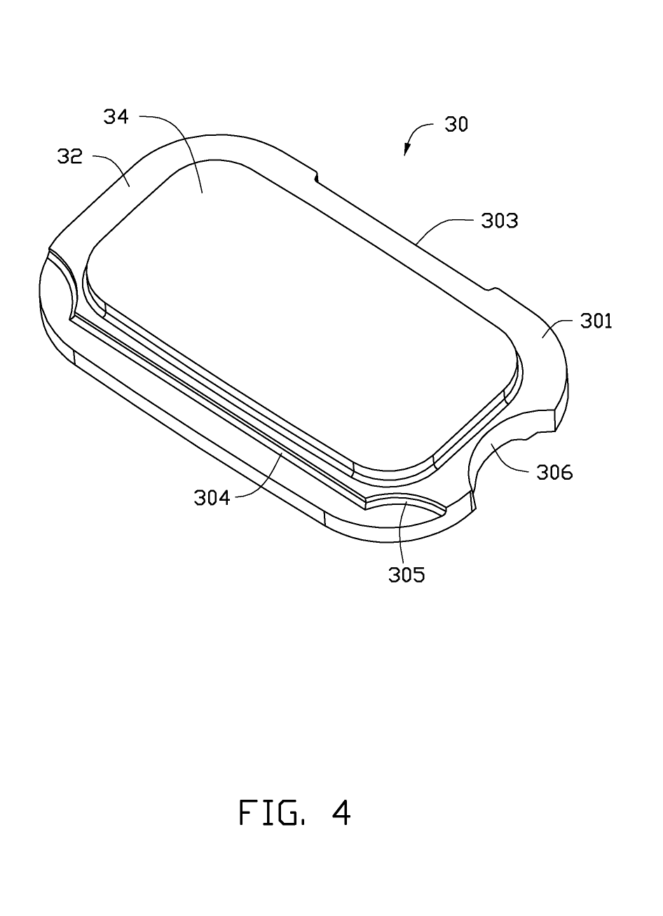

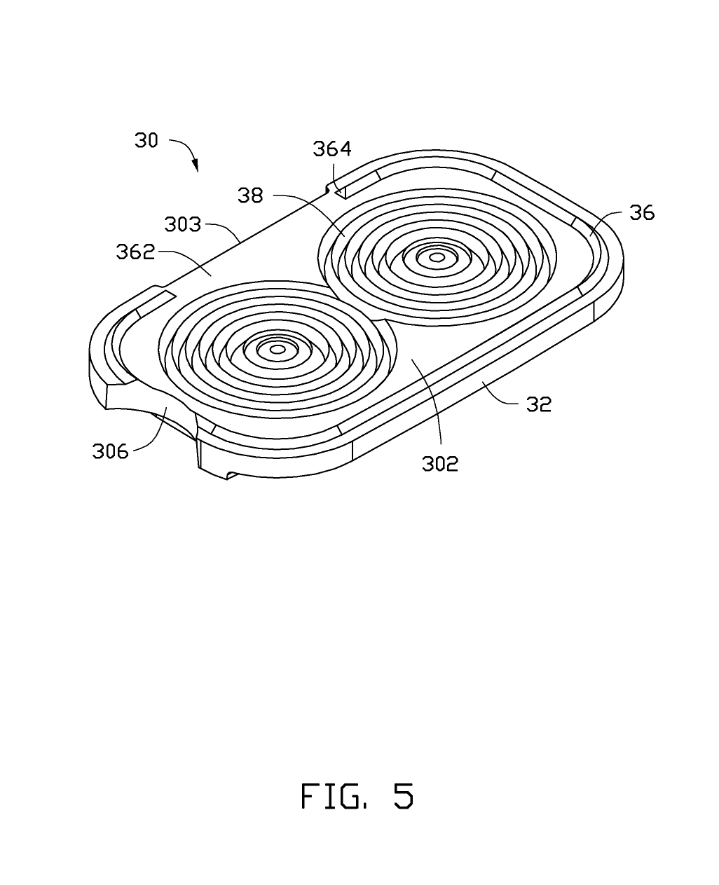

FIG. 4 and FIG. 5 show the decorative cover 30 assembled in the light hole 15 and covering the flash unit received in the light hole 15. The decorative cover 30 is made of transparent material, which allows the light generated by the flash unit to be transmitted therethrough. In the present embodiment, the decorative cover 30 is made of acrylic material. The decorative cover 30 is a rectangular plate. The four corner portions of the decorative cover 30 can be rounded to prevent the stress from centralizing when molding the decorative cover 30.

The decorative cover 30 includes a main portion 32, a projecting portion 34, a strip portion 36, and a disk portion 38. The main portion 32 is a substantially rectangular plate and defines an indent 303 on a first edge, an arcuate recess 306 on a second edge adjacent to the first edge, a step 304 on third edge opposite to the indent 303, and two arcuate bevels 305 on opposite ends of the step 304. The main portion 32 further includes a first surface 301 and a second surface 302 opposite to the first surface 301. The projecting portion 34 protrudes from the first surface 301 and has a smaller size of area than the main portion 32. The main portion 32 and the projecting portion 34 have rounded corners for preventing the stress from centralizing during the molding process. The strip portion 36 protrudes from the second surface 302, adjacent and along the edges of the second surface 302. The strip portion 36 defines an opening 362 corresponding to the length of the indent 303. The strip portion 36 includes two bevel shaped distal ends 364 corresponding to the ends of the opening 362. In the present embodiment, the strip portion 36 is arranged for ultrasonic welding with the supporting portion 152. Each bevel-shaped distal end 364 of the strip portion 36 forms a smooth weld junction with the supporting portion 152 and thus keeping the stress away from the opening 362 during the welding process, therefore preventing the decorative cover 30 from being pressed then causing white mark defect due to being entrance during molding process. The two disk portions 38 are formed on the second surface 302, adjacent to each other. Each disk portion 38 includes a plurality of concentric circular protrusions protruding from the second surface 302. The plurality of concentric circular protrusions forms a convex outside surface.

The decorative cover 30 is made by injection molding. The indent 303 and the opening 362 of the strip portion 36 can be entrances for the injection material in molding, to keep the injection material from accumulating. The four arcuate corners of the decorative cover 30 and the two arcuate bevels 305 keep the stress from centralizing during the molding process which may cause damage to the decorative cover 30.

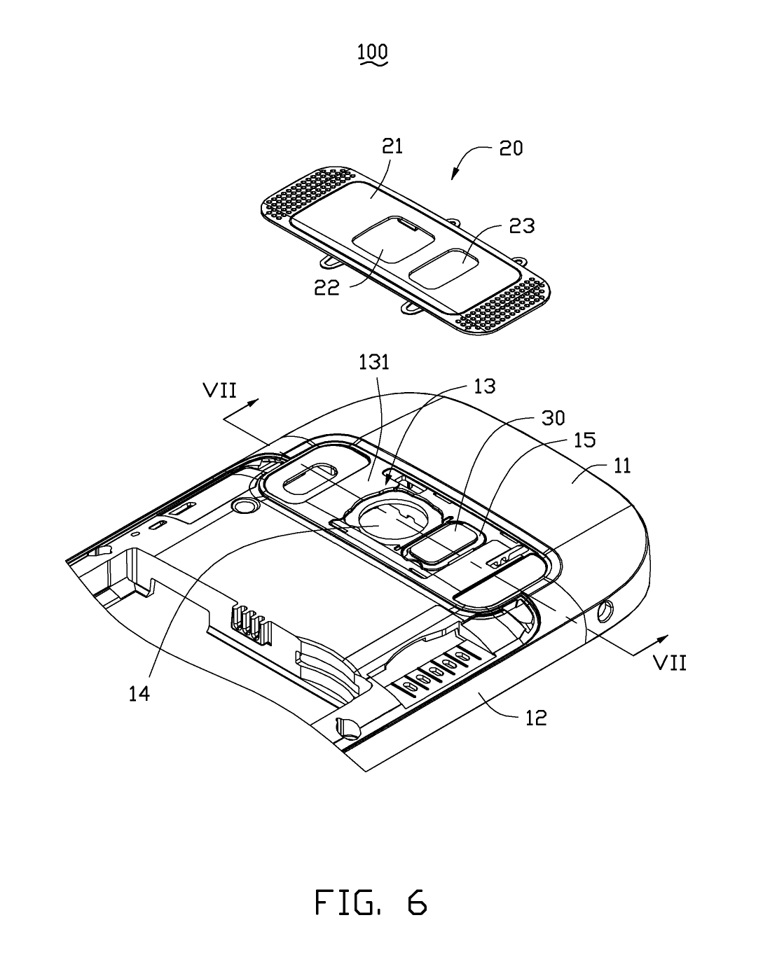

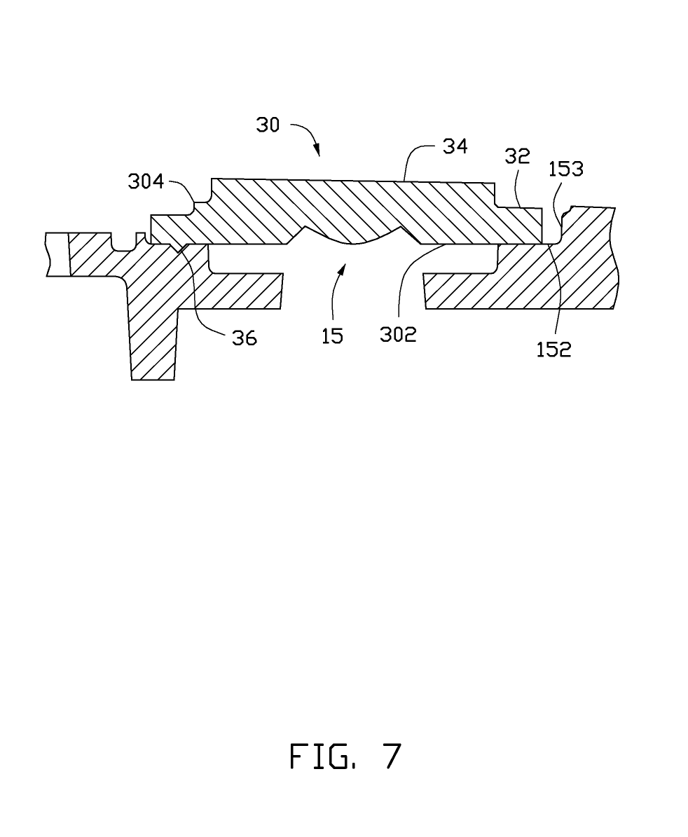

FIGS. 6 and 7 show that in assembly, the decorative cover 30 is assembled to the groove 13 of the main body 10. The second surface 302 of the main portion 32 of the decorative cover 30 is mounted towards the light hole 15 and is spelling to the top of the supporting portion 152. The recess 306 of the main portion 32 is engaged with the protrusion 154 of the light hole 15. The second surface 302 of the main portion 32 is joined to the supporting portion 152 by using ultrasonic welding, and the strip portion 36 is welded and inserted into the supporting portion 152. Thus, the decorative cover 30 abuts to the supporting portion 152, so that it is air tight and water proof at the junction between the decorative cover 30 and the supporting portion 152. Therefore, the decorative cover 30 covers the flash unit to avoid any external contact and keeping any dust and moisture interference.

After the decorative cover 30 is mounted on the light hole 15, the disk portions 38 are corresponding to the flash unit, so that the light generated by the flash unit is refracted by the plurality of concentric circular protrusions of the disk portions 38 and transmits through the decorative cover 30, which improves the flash dispersal effect. In addition, the main portion 32 is aligned with the surrounding wall 153 and the projecting portion 34 protrudes from the bottom wall 131. Subsequently, the ornamental piece 20 is assembled to the groove 13, then the ledge 21 is aligned with the projecting portion 34, thus, the decorative cover 30 is assembled.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A decorative cover mounted on an electronic device corresponding to a flash unit of the electronic device, comprising:
a main portion defining an indent and a step opposite to the indent;
a strip portion formed along a peripheral edge of on a surface of the main portion and defining an opening corresponding to the indent, wherein two distal ends of the strip portion are beveled, and the strip portion is welded and inserted into a housing of the electronic device to be attached to the housing of the electronic device.

2. The decorative cover of claim 1, wherein the decorative cover is a rectangular plate, four corners of the decorative cover are rounded to prevent stress from centralizing during molding process of the decorative cover.

3. The decorative cover of claim 1, wherein the main portion further defined a recess adjacent to the indent, the recess is configured for connecting housing of the electronic device.

4. The decorative cover of claim 1, wherein the decorative cover is made of transparent material.

5. The decorative cover of claim 1, further comprising at least one disk portion formed on the surface of the main portion, the disk portion includes a plurality of concentric circular protrusions protruding from the surface of the main portion for improving the flash dispersal effect.

6. The decorative cover of claim 1, further comprising a projecting portion form on another surface of the main portion opposite to the strip portion, the projecting portion is smaller in size than the main portion.

7. The decorative cover of claim 1, wherein the opening of the strip portion and the indent are entrances for injection material during molding process of the decorative cover.

8. The decorative cover of claim 1, wherein the two opposite ends of the step of the main portion define two arcuate bevels, the two arcuate bevels are configured for avoiding the stress centralizing during molding process of the decorative cover.

9. A housing of an electronic device defining a light hole configured for receiving a flash unit, the housing comprising a decorative cover mounted on the light hole, the decorative cover being made of transparent material and comprising:
a main portion defining an indent and a step opposite to the indent;
a strip portion formed along a peripheral edge of on a surface of the main portion and defining an opening corresponding to the indent, wherein two distal ends of the strip portion are bevel in shape, the strip portion is for being welded and inserted into housing corresponding to the light hole to be attached to the housing of the electronic device, thus the decorative cover is configured for covering the flash unit and transmitting light.

10. The housing of the electronic device of claim 9, wherein the light hole includes a supporting portion, a surrounding wall, a center hole, and a protrusion, the supporting portion surrounds the center hole in a center portion, the surrounding wall is formed by extending a peripheral edge of the top of the supporting portion, the protrusion is protruded from an end of the surrounding wall and is projected into the light hole.

11. The housing of the electronic device of claim 10, wherein the strip portion is welded and inserted into the supporting portion when the decorative cover is assembled to the housing.

12. The housing of the electronic device of claim 10, wherein the main portion further defined a recess adjacent to the indent, the recess is engaged with the protrusion of the housing.

13. The housing of the electronic device of claim 10, wherein the main portion further includes a projecting portion form on another surface of the main portion opposite to the strip portion, the projecting portion is smaller in size than the main portion, the projecting portion is protruded from the surrounding wall of the light hole when the decorative cover is assembled to the housing.

14. The housing of the electronic device of claim 13, further defining a camera hole adjacent to the light hole, wherein the camera hole is configured for receiving a camera.

15. The housing of the electronic device of claim 14, further comprising an ornamental piece mounted to the camera hole and the light hole, wherein the ornamental piece includes a first hole and second hole corresponding to the camera hole and the light hole respectively, the ornamental piece is aligned with the projecting portion of the decorative cover.

16. The housing of the electronic device of claim 9, wherein the main portion further includes at least one disk portion formed on the surface of the main portion, the disk portion includes a plurality of concentric circular protrusions protruding from the surface of the main portion, the plurality of concentric circular protrusions are configured for improving the flash dispersal effect.

17. The housing of the electronic device of claim 9, wherein the opening of the strip portion and the indent import injection material when molding process of the decorative cover.

18. The housing of the electronic device of claim 9, wherein the two opposite ends of the step of the main portion define two arcuate bevels, the two arcuate bevels are configured for avoiding the stress centralizing during molding process of the decorative cover.
